(19) United States
(12) Patent Application Publication
(10) Pub. No.: US 2012/0125149 A1
(43) Pub. Date: May 24, 2012

(54) MOTOR STARTER INCLUDING AN ARMATURE HAVING AN INTEGRAL DRIVE SYSTEM

(75) Inventors: Balazs Palfai, Fishers, IN (US); Attila Nagy, Fishers, IN (US)

(73) Assignee: REMY TECHNOLOGIES, L.L.C., Pendleton, IN (US)

(21) Appl. No.: 12/950,455

(22) Filed: Nov. 19, 2010

(51) Int. Cl. F02N 11/00; H02K 7/116

(52) U.S. Cl. 74/7 C; 74/7 R; 74/7 E; 310/83

(57) ABSTRACT

A motor starter includes a housing having an exterior surface and an interior surface that defines an interior portion, a field coil mounted to the interior surface of the housing, and an armature is supported within the housing and rotatable relative to the field coil. The armature includes a shaft having an exterior surface and a hollow interior. A commutator is operatively connected to the shaft, and a drive system is arranged within the hollow interior of the shaft. The drive system includes a gear system. An output shaft is operatively connected to the gear system.

### BACKGROUND OF THE INVENTION

Exemplary embodiments pertain to the art of electric machines and, more particularly, to a motor starter including an armature having an integral drive system.

Conventional internal combustion engines employ a motor starter to initialize motor rotation. Once initialized, combustion gases provide energy to maintain the motor rotation. Thus, once the engine begins normal operation, the motor starter must disengage. A typical motor starter includes an armature having a commutator and a plurality of windings arranged within a magnetic field. Electrical energy is passed through two or more brushes into the commutator. The electrical energy is transformed into magnetic energy that causes the armature to rotate. The rotation of the armature is imparted to a fly wheel of the internal combustion engine.

The motor starter typically includes a reduction gear that reduces number of rotations of the armature that are transferred to the fly wheel. The reduction gear is typically connected to a pinion gear that is selectively moved into engagement with the fly wheel. A solenoid, mounted to the motor starter, selectively extends the pinion gear into engagement with the fly wheel upon activation of the starter motor. The pinion gear is retracted upon cessation of power to the motor starter. In addition to the reduction gear, the motor starter typically includes a clutch operatively coupled to the pinion gear. The clutch ensures that the fly wheel does not over spin the motor starter when the internal combustion engine starts.

### BRIEF DESCRIPTION OF THE INVENTION

Disclosed is a motor starter including a housing having an exterior surface and an interior surface that defines an interior portion, a field coil mounted to the interior surface of the housing, and an armature rotatably supported within the housing relative to the field coil. The armature includes a shaft having an exterior surface and a hollow interior. A drive system is arranged within the hollow interior of the shaft. The drive system includes a gear system.

Also disclosed is an armature including a shaft having an exterior surface and a hollow interior, a commutator operatively connected to the shaft, and a drive system arranged within the hollow interior of the shaft. The drive system includes a gear system. An output shaft is operatively connected to the gear system.

### BRIEF DESCRIPTION OF THE DRAWINGS

The following descriptions should not be considered limiting in any way. With reference to the accompanying drawings, like elements are numbered alike:

FIG. 1 is a partial cross-sectional view of a motor starter including an armature having an integral drive system in accordance with an exemplary embodiment;

FIG. 2 is a perspective, cross-sectional view of the armature of FIG. 1; and

FIG. 3 is an exploded view of the armature of FIG. 2.

### DETAILED DESCRIPTION OF THE INVENTION

A detailed description of one or more embodiments of the disclosed apparatus and method are presented herein by way of exemplification and not limitation with reference to the Figures.

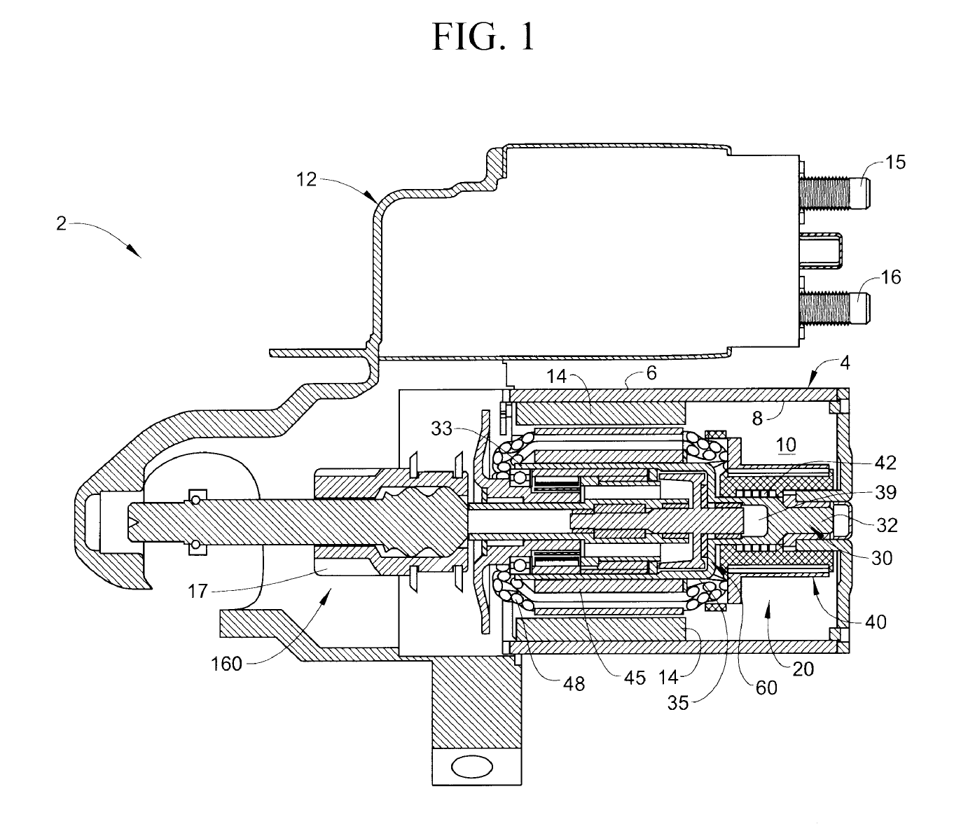

With reference to FIG. 1, a motor starter in accordance with exemplary embodiments is indicated generally at 2. Motor starter 2 includes a housing 4 having an exterior surface 6 and an interior surface 8 that defines an interior portion 10. A solenoid 12 is mounted to exterior surface 6 and a field coil 14 is mounted to interior surface 8. Solenoid 12 includes a plurality of electric terminals two of which are indicated at 15 and 16. Electric energy is passed to terminals 15 and 16 to activate solenoid 12. Solenoid 12 in turn shifts a drive gear or pinion 17 into engagement with a ring gear portion of a fly wheel (not shown) provided on, for example, an internal combustion engine (also not shown). Once extended, pinion 17 rotates imparting a corresponding rotation to the fly wheel to facilitate starting of the internal combustion engine. Motor starter 2 includes an armature 20 that is rotated upon application of an electrical current.

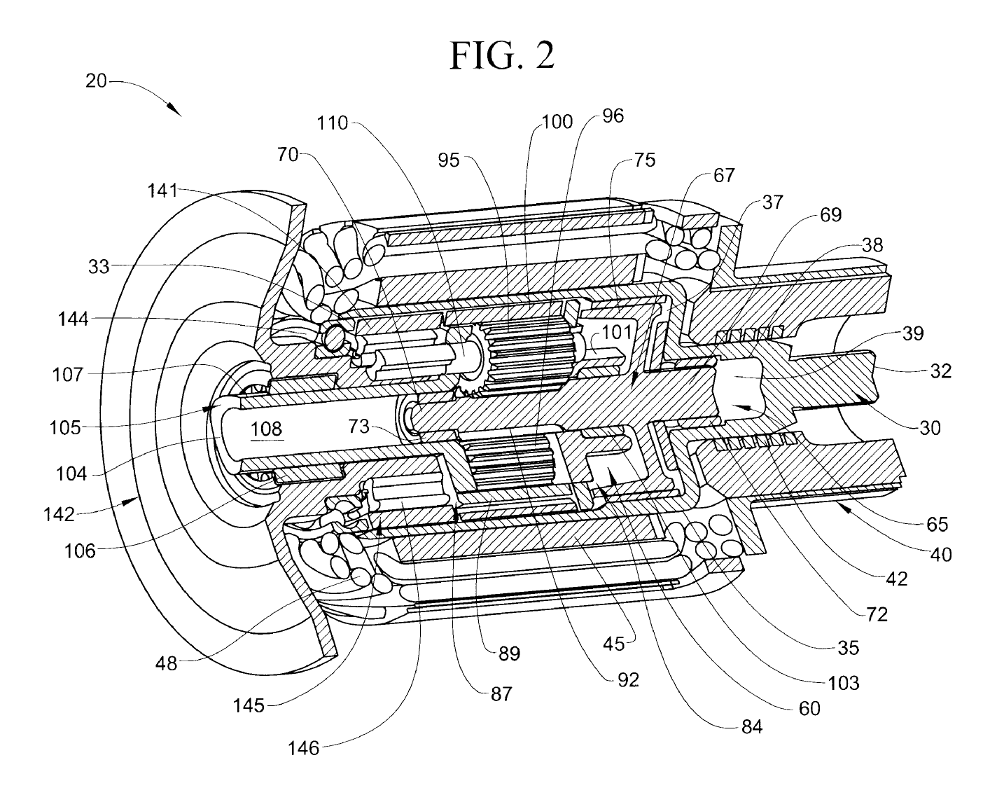

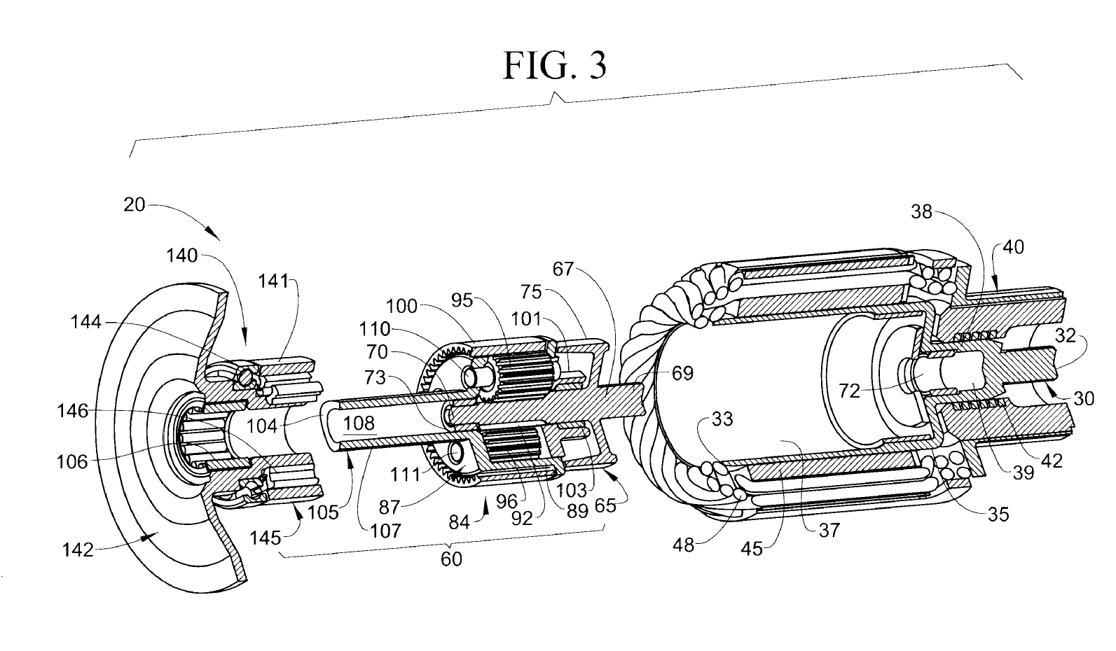

As best shown in FIGS. 2-3, armature 20 includes a shaft 30 having a first end 32 that extends to a second end 33. Shaft 30 includes an exterior surface 35 and a hollow interior 37. Shaft 30 is also shown to include a step region 38 and an internal recess region 39 at first end 32. Armature 20 includes a commutator 40 coupled to shaft 30 at first end 32 through a commutator bushing 42. Commutator 40 is electrically coupled to a plurality of armature laminations 45 through a plurality of armature windings 48. Commutator 40 is also electrically connected to terminals 15 and 16 through a plurality of electrical brushes (not shown). Armature 20 is further shown to include an integral drive system 60. Drive system 60 translates rotation of armature 20 to pinion 17 as will be discussed more fully below.

In accordance with the exemplary embodiment, drive system 60 includes a torque limiter system 65 that minimizes torque fluxes into shaft 30. Torque limiter system 65 includes a shaft 67 having a first end section 69 that extends to a second end section 70. First end section 69 is supported within internal recess region of shaft 30 through a first bushing 72. Second end section 70 is rotatably supported by a second bushing 73. In the exemplary embodiment shown, torque limiter system 65 includes a torque limiting member 75 arranged at first end section 69.

Drive system 60 also includes a gear system 84, which in accordance with one aspect of the exemplary embodiment, takes the form of a reduction gear system. Gear system 84 includes a planetary gear set 87 having a carrier 89, a sun gear 92 supported upon shaft 67, and a plurality of planet gears, two of which are shown at 95 and 96, and a ring gear 100. Carrier 89 includes a first end 101 that is supported upon shaft 67 through a first carrier bushing 103 and a second end 104 that defines an output shaft 105 that is supported by a bearing 106 as will be discussed more fully below. Output shaft 105 includes an outer surface 107 and an internal bore 108. Planet gears 95 and 96 are supported upon planet gear shafts 110 and 111.

Drive system 60 is further shown to include a clutch system 140 that is operatively connected to output shaft 105. Clutch system 140 includes a clutch outer race 141 and a clutch inner race 142. In accordance with one aspect of the exemplary embodiment, clutch outer race 141 is formed with ring gear 100. Of course it should be understood that the components may also be formed and mounted independently of one another. Clutch inner race 142 is fixedly mounted relative to housing 4 and rotatably supports second end 33 of shaft 30 through a bearing 144. Clutch system 140 includes a plurality of clutch members 145 that in one embodiment take the form of sprag elements 146. Thus, in accordance with the exemplary embodiment shown, clutch system 140 takes the form of a sprag clutch. While shown as a sprag clutch it should be understood that various other types of clutch components may be employed. Clutch system 140 is configured to prevent any over-run of armature 20 in the event that pinion 17 remains engaged with the fly wheel after the engine begins operation. Thus, clutch assembly 140 provides an interface between output shaft 105 and an output assembly 160 that supports pinion 17.

At this point it should be understood that the exemplary embodiments provide for a motor starter that includes an armature having an integral drive system. Forming the drive system internally with the armature provides for a smaller overall foot print for the motor starter. Reducing the foot print of the motor starter allows manufactures greater flexibility in engine design and/or engine compartment and other drive component arrangement. In addition, arranging the drive system integrally with the armature lowers a traveling or translating mass of components that are shifted by the solenoid. Lowering the translated mass allows manufactures to reduce solenoid size and power requirements. Moreover, the reduction in translated mass leads to a reduction in deterioration of the vehicle's ring gear provided on the fly wheel.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A motor starter comprising:
a housing having an exterior surface and an interior surface that defines an interior portion;
a field coil mounted to the interior surface of the housing; and
an armature supported within the housing and rotatable relative to the field coil, the armature including:
a shaft including an exterior surface and a hollow interior;
a commutator operatively connected to the shaft;
a drive system arranged within the hollow interior of the shaft, the drive system including a gear system; and
an output shaft operatively connected to the gear system.

2. The motor starter according to claim 1, wherein the gear system is a reduction gear system.

3. The motor starter according to claim 2, wherein the reduction gear system includes at least one planetary gear set.

4. The motor starter according to claim 3, wherein the planetary gear set includes a ring gear operatively connected to the shaft.

5. The motor starter according to claim 1, wherein the drive system includes a torque limiting member.

6. The motor starter according to claim 5, wherein the drive system includes a clutch member.

7. The motor starter according to claim 6, wherein the clutch member comprises sprag elements.

8. The motor starter according to claim 6, wherein the gear system is mounted in a carrier having a first end and a second end, the torque limiting member being operatively connected to the first end of the carrier and the clutch member being operatively coupled to the second end of the carrier.

9. The motor starter according to claim 8, wherein the second end of the carrier constitutes the output shaft.

10. The motor starter according to claim 1, wherein the armature includes a plurality of laminations mounted to the exterior surface of the shaft.

11. An armature comprising:
a shaft including an exterior surface and a hollow interior; and
a drive system arranged within the hollow interior of the shaft, the drive system including a gear system.

12. The armature according to claim 11, wherein the gear system is a reduction gear system.

13. The armature according to claim 12, wherein the reduction gear system includes at least one planetary gear set.

14. The armature according to claim 13, wherein the planetary gear set includes a ring gear operatively connected to the shaft.

15. The armature according to claim 11, wherein the drive system includes a torque limiting member.

16. The armature according to claim 15, wherein the drive system includes a clutch member.

17. The armature according to claim 16, wherein the clutch member comprises a plurality of sprag elements.

18. The armature according to claim 16, wherein the gear system is mounted in a carrier having a first end and a second end, the torque limiting member being operatively connected to the first end of the carrier and the clutch member being operatively coupled to the second end of the carrier.

19. The armature according to claim 18, further comprising: an output shaft operatively connected to the gear system.

20. The armature according to claim 11, further comprising: a commutator operatively connected to the shaft.
